(19) United States
(12) Patent Application Publication
(10) Pub. No.: US 2005/0256979 A1
(43) Pub. Date: Nov. 17, 2005

(54) [DIRECT MEMORY ACCESS METHOD FOR CARD READER AND A METHOD FOR PROGRAMMING CONTROLLER OF CARD READER]

(76) Inventor: Kuo-Chao Lin, Hsinchu City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/710,623

(22) Filed: Jul. 26, 2004

(30) Foreign Application Priority Data
May 11, 2004 (TW) 93113136

(51) Int. Cl. G06F 13/28

(52) U.S. Cl. 710/22

(57) ABSTRACT

A direct memory access method for A card reader and a method for programming A controller of the card reader are provided. This method actively sets the DMAC and uses the table established by the block status recording area of the memory card to set the DMAC parameter set. The DMAC parameter set is moved to the memory block allocated by the system. Each parameter set includes the initial address for the next parameter set. Hence, by giving the initial address of the DMAC parameter set, can read the DMAC parameters and move the data based on the DMAC parameters. After moving one block, the DMAC will automatically read the next DMAC parameter set. Hence, the reading speed can be enhanced.

### CROSS REFERENCE TO RELATED APPLICATIONS

This application claims the priority benefit of Taiwan application serial no. 93113136, filed on May 11, 2004.

### BACKGROUND OF INVENTION

1. Field of the Invention

This invention generally relates to a direct memory access (DMA) method, and more particularly to a direct memory access method for a card reader and a method for programming a controller of the card reader.

2. Description of Related Art

As electronic technology advances, consumers have more chances using a card reader. Hence, the functions of a card reader are the main interests to the consumers. Generally, the transmission rate between the card reader and the memory card attracts the most concerns. The fastest way to access memory in a PC platform is via the direct memory access (DMA) method. Similarly, DMA can also be applied to access data in a memory card. Memory cards using the DMA method to access data includes memory cards without the function of moving multiple data blocks and memory cards with the function of moving multiple data blocks.

FIG. 1 is a flow chart for using the DMA method in a memory card without the function of moving multiple data blocks according to the prior art. First, in step S101, a memory block is allocated when the system is going to move the data in the memory card via the DMA method. In step S103, a DMA controller (DMAC) is set. In step 105, the range of the specific block of data is set to move. In step 107, the DMA is performed. In step 109, the data in the single block set in the step S105 is moved via the DMA method. In step S111, the DMAC sends an interrupting vector after the data in the specific block have been moved. In step S113, the system acknowledges that the data has been moved after it receives the interrupting vector, and the system enters into an interrupting service program. In step S115, the system will wait for the next DMA request to repeat steps S101 through S113.

FIG. 2 is a traditional flow chart for using the DMA method in a memory card with the function of moving multiple data blocks. First, instep S201, a memory block is allocated when the system is going to move the data in the memory card via the DMA method. In step S203, the address of the read/write block is determined based on the embedded memory card block status and a DMAC is set. In step S205, multiple blocks for this particular data are set to move. In step 207, the DMA is performed. In step 209, the data in the multiple blocks set in the step S205 is moved via the DMA. In step S211, the DMAC sends an interrupting vector after the data in the specific block have been moved. In step S113, the system acknowledges that the data has been moved after it receives the interrupting vector, and the system enters into an interrupting service program.

According to the above two traditional flow charts, for the memory card without the function of moving multiple data blocks, the DMAC has to be set again for moving each block. FIG. 3 shows the time sequence of a memory card uses the DMA when the memory card is without the function of moving multiple data blocks. If CLK represents the system internal clock signal, an enable signal is given to set the DMAC at time T1. At time T2, the data in the first block is moved. If the data in the next block is going to be transmitted, at time T3, the DMAC has to be set again, and at time T4, the data in the second block is moved. Then, at time T5, the DMAC has to be set again, and at time T6, the data in the third block is moved. Hence, if there are three blocks going to be transmitted in the memory card without the function of moving multiple data blocks, the DMAC has to be set for three times.

For the memory card with the function of moving multiple data blocks, the DMAC has to be set once before performing the DMA. FIG. 4 shows the time sequence of the memory card uses the DMA when the memory card is with the function of moving multiple data blocks. As shown in FIG. 4, when moving the data in three blocks, the DMAC is only required to be set once at time T1. At times T2, T3, and T4, the data in the three blocks are transmitted in order. At time T5, the data transmission for the three blocks is completed. Compared to FIG. 3, because the DMAC setting is twice reduced by and the interruption is twice reduced, the transmission efficiency has been significantly enhanced. However, not all memory cards have the function of moving multiple data blocks. Hence, how to enhance the efficiency of the memory card without the function of moving multiple data blocks becomes an important issue.

### SUMMARY OF INVENTION

An object of the present invention is to provide a direct memory access method for a card reader and a method for programming the controller of the card reader. The method includes actively setting the DMAC and using the table established by the block status recording area of the memory card to set the parameters. As a result, the memory card without the function of moving multiple data blocks can uses the memory card with the function of moving multiple data blocks to perform DMA in order to enhance the transmission rate of the memory card.

The present invention provides a direct memory access method for a card reader, wherein the card reader includes a direct memory access controller and is coupled to a system. The system includes a main memory and a control software. The system executes a driver program to control the card reader. The direct memory access method comprises: allocating an area of the main memory; establishing a reading table via the control software; setting a parameter set group based on the reading table and moving the parameter set group to the area of the main memory; acquiring an initial address of the parameter set group; reading a parameter value from the initial address; using a direct memory access method to move data based on the parameter value; repeating the above steps before reading all the parameter values; and sending out an interrupting signal to the system to inform the system that the direct memory access is completed.

In an embodiment of the present invention, the reading table is established based on a block status recording area of a memory card.

In an embodiment of the present invention, the parameter set group is moved by the driver program. The initial address of the parameter set group is provided by the driver program to the direct memory access controller. Each parameter set of the parameter set group includes an origin address of the data and a target address of the data. The parameter set group at least includes a plurality of parameter sets and each of the plurality of parameter sets assigns a direct memory access range. At least one of the plurality of parameter sets includes a parameter indicating an initial address of a following parameter set.

The present invention provides a method for programming a direct memory access controller of a card reader, wherein the card reader includes a direct memory access controller and is coupled to a system. The system includes a main memory and a control software. The system generates a driver program. The control software establishes a reading table. The driver program sets a parameter set group based on the reading table and the parameter set group is moved to the area of the main memory,. The system executes the driver program to control the card reader. The method comprises: the driver program providing an initial address of the parameter set group to the direct memory access controller; the direct memory access controller reading a parameter value from the initial address; the direct memory access controller using a direct memory access method to move data based on the parameter value; and repeating the above steps before reading all the parameter values.

In an embodiment of the present invention, the reading table is established based on a block status recording area of a memory card.

In a preferred embodiment of the present invention, the parameter set group at least includes a parameter set, wherein each parameter set of the parameter set group includes an origin address of the data and a target address of the data. The parameter set group at least includes a plurality of parameter sets and each of the plurality of parameter sets assigns a direct memory access range.

In light of the above, the present invention actively sets the DMAC and uses the table established by the block status recording area of the memory card to set the DMAC parameter set. The DMAC parameter set is moved to the memory block allocated by the system. Each parameter set includes the initial address for the next parameter set.

Hence, by providing the DMAC parameter set with the initial address of the first parameter set, the DMAC can read the DMAC parameters and move the data based on the DMAC parameters. After moving the data, the DMAC will automatically read the next DMAC parameter set. Hence, the reading speed is enhanced.

One or part or all of these and other features and advantages of the present invention will become readily apparent to those skilled in this art from the following description wherein there is shown and described a preferred embodiment of this invention, simply by way of illustration of one of the modes best suited to carry out the invention. As it will be realized, the invention is capable of different embodiments, and its several details are capable of modifications in various, obvious aspects all without departing from the invention. Accordingly, the drawings and descriptions will be regarded as illustrative in nature and not as restrictive.

### BRIEF DESCRIPTION OF DRAWINGS

FIG. 1 is a flow chart for using the DMA in the memory card without the function of moving multiple data blocks according to the prior art.

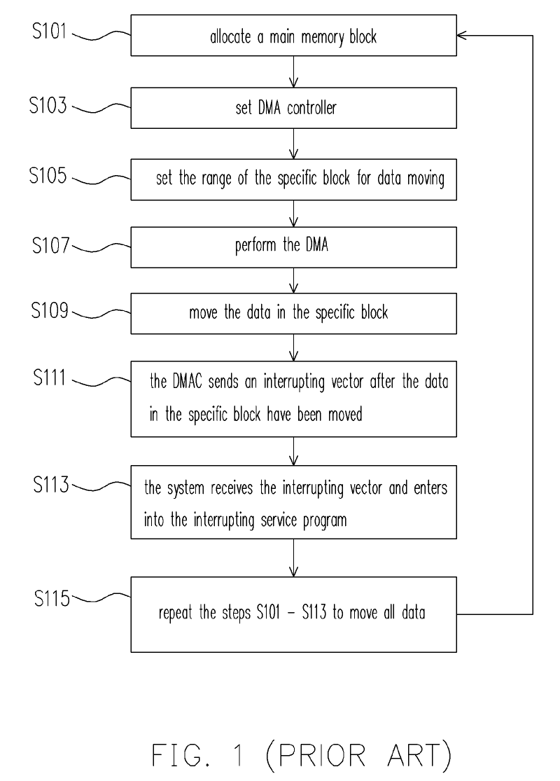

FIG. 2 is a traditional flow chart for using the DMA in the memory card with the function of moving multiple data blocks according to the prior art.

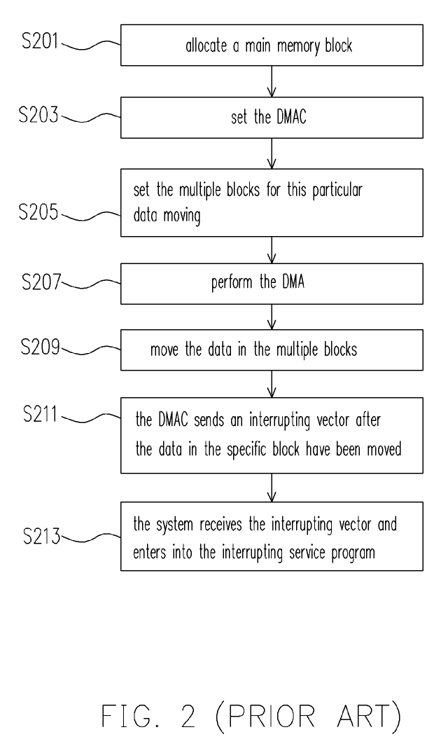

FIG. 3 shows the time sequence of a memory card uses the DMA when the memory card is without the function of moving multiple data blocks according to the prior art.

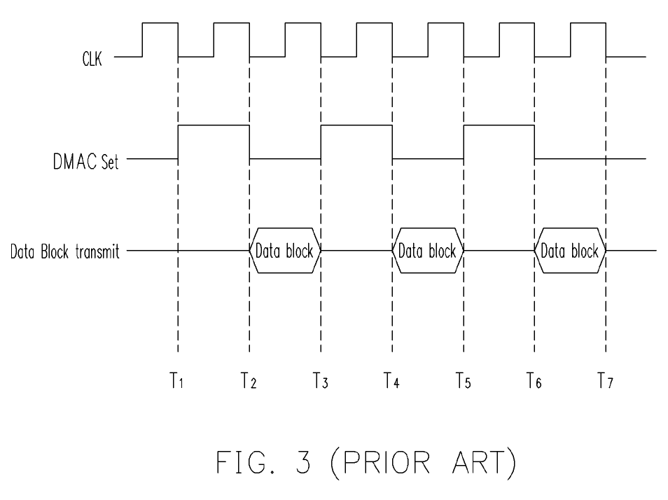

FIG. 4 shows the time sequence of memory card uses a DMA when the memory card is with the function of moving multiple data blocks according to the prior art.

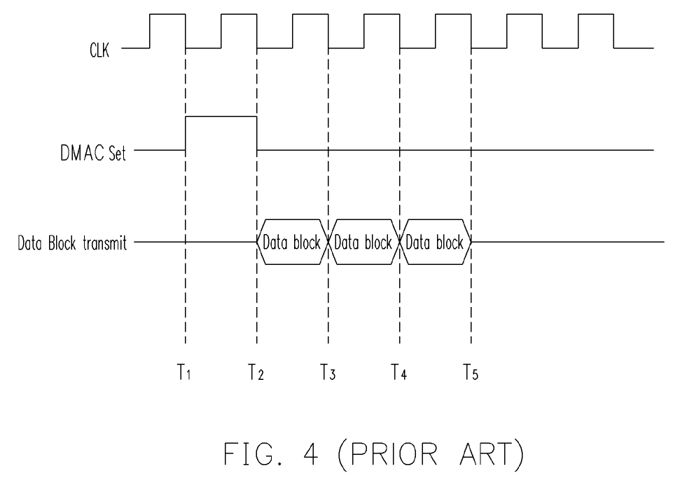

FIG. 5 is a block diagram of a card reader and an external system in accordance to the application of an embodiment of the present invention.

FIG. 6 is a flow chart illustrating the process flow of the DMA method for a card reader in accordance to an embodiment of the present invention.

FIG. 7 illustrates the parameter sets for the DMA method of a card reader in accordance to an embodiment of the present invention.

FIG. 8 is a flow chart for programming DMAC of a card reader in accordance to an embodiment of the present invention.

### DETAILED DESCRIPTION

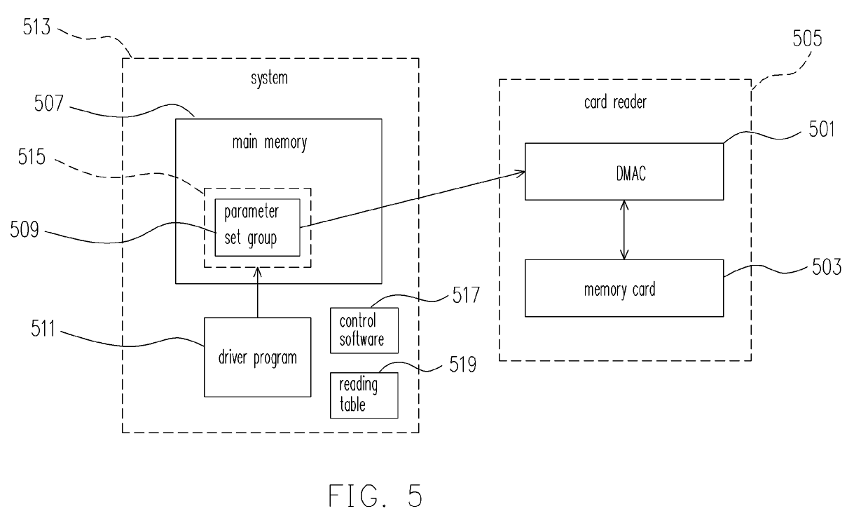

FIG. 5 is a block diagram of a card reader and a external system in accordance to an application of an embodiment of the present invention. As shown in FIG. 5, t a main memory 507 in a system 513 is provided, wherein a direct memory access control (DMAC) 501 and a memory card 503 are in the card reader 505. Before using the card reader 505, a driver program 511 has to be established in the system 513. The driver program 511 identifies all blocks for moving and organizes them as a parameter set group 509. The driver program 511 then moves the parameter set group 509 to a memory area 515 of the main memory 507. The parameter set group 509 at least includes a parameter set. Each parameter set records a DMA range, which includes the origin address and the target address of the data for moving, and the initial address of the next parameter set. The above parameter set group 509 is determined by a control software 517 based on the reading table 519 that is established by the block status recording area of the memory card. For the memory card with the function of moving multiple data blocks, the table is embedded.

When the parameter set group 509 is moved to the main memory 507, the driver program 511 will send the first initial address of the parameter set group 509 to the DMAC 501 of the card reader 505. The DMAC 501 then starts to read the data from that initial address. The DMAC 501 starts to perform the DMA based on the parameter value. When the parameter set read by the DMAC 501 is not the last parameter set, the last parameter of this parameter set will indicate the initial address of the following parameter to be read. The DMAC 501 then based on the initial address of the following parameter reads the data corresponding to following parameter set until the data corresponding to the last parameter set is read.

As described above, if the addresses of the data of the multiple block are converted to the parameter values in the parameter set group, the DMAC 501 in the card reader can perform the DMA by reading the parameter set group 509 in the main memory 507 of the system 513. By using the method, the memory card without the function of moving multiple data blocks can be read by the DMA method.

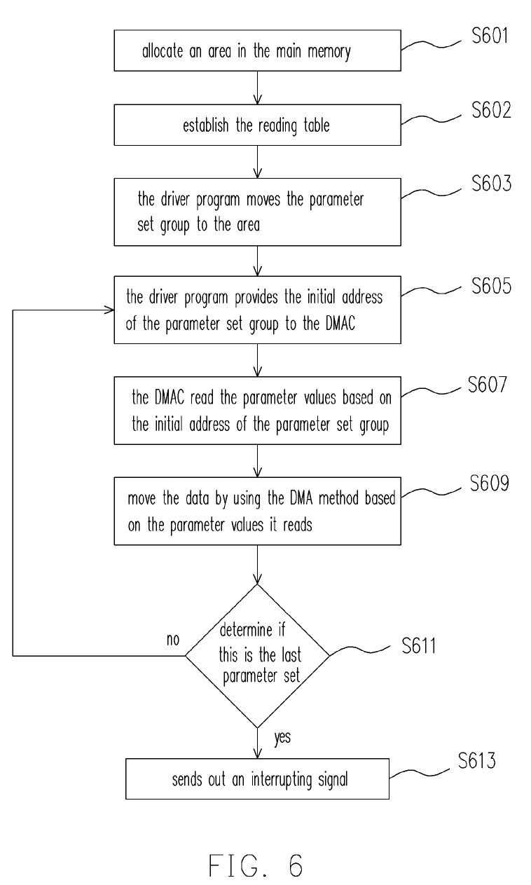

FIG. 6 is a flow chart illustrating the process flow of the DMA method for a card reader in accordance to an embodiment of the present invention. In step S601 an area in the main memory is allocated. In step S602, the control software establishes the reading table based on the block status recording area of the memory card. In step S603, the parameter set group is established based on the reading table and that the driver program moves the parameter set group to the area allocated in the main memory. In step S605, is the driver program provides the initial address of the parameter set group to the DMAC. In step S607, is the DMAC reads the parameter values based on the initial address of the parameter set group. In step S609, the DMAC moves the data by using the DMA method based on the parameter values. In step S611, when the DMAC reads the parameter values of a parameter set, the data has not been completely read if the initial address of the next parameter set is read. Hence, the DMAC will go back to step S605 and read the parameter values of the next parameter set. If the parameter set does not include the initial address of the next parameter set, it means that it is the last parameter set. Then, the flow chart goes to step S613, where the DMAC sends out an interrupting signal to inform the system that the DMA operation has been completed.

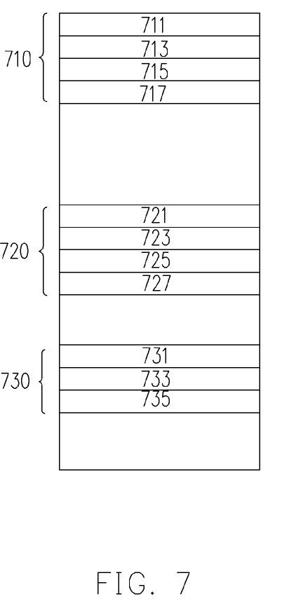

FIG. 7 illustrates the parameter sets for the DMA method of a card reader in accordance to an embodiment of the present invention. As shown in FIG. 7, the parameter set group includes the first parameter set 710, the second parameter set 720, and the third parameter set 730. The first parameter set 710 includes four parameter values 711, 713, 715, and 717. The second parameter set 720 includes four parameter values 721, 723, 725, and 727. The third parameter set 730 includes four parameter values 731, 733, and 735. The DMAC will move the data based on the content of each parameter value.

If the initial address of the parameter set group of the DMAC receives is the initial address 711 of the first parameter set 710, the DMAC reads the parameter value from the address 711 and then reads the parameter values 713, 715, and 717 in that order. If the content of the parameter value 717 is to direct to the initial address 721 of the second parameter set 720, the DMAC continues to read the parameter values from the initial address 721 of the second parameter set 720 and reads the parameter values 721, 723, 725, and 727 in that order. If the content of the parameter value 727 is to direct to the initial address 731 of the third parameter set 730, the DMAC continues to read the parameter values from the initial address 731 of the third parameter set 730 and reads the parameter values 731, 733, and 735 in that order. In the third parameter set 730, because there is no parameter value indicating the initial address of the next parameter set, it means that it is the last parameter set. After the DMAC read the parameter values of the last parameter set, the DMAC completes the DMA operation.

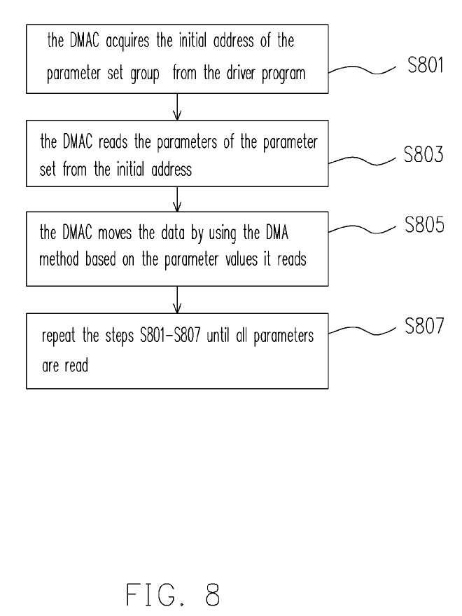

FIG. 8 is a flow chart for programming DMAC of a card reader in accordance to an embodiment of the present invention. As shown in FIG. 8, in step S801, the DMAC acquires the initial address of the parameter set group from the driver program. In step S803, the DMAC reads the parameters of the parameter set from the initial address. In step S805, the DMAC moves the data by using the DMA method based on the parameter values it reads. In step S807, if there are some parameter sets have not been read, the DMAC will repeat the above steps until all parameters are read.

The present invention actively sets the DMAC and uses the table established by the block status recording area of the memory card to set the DMAC parameter set. The DMAC parameter set is moved to the memory area allocated by the system. Each parameter set includes the initial address for the next parameter set. Hence, by giving the initial address of the DMAC parameter set, the DMAC can read the DMAC parameters and move the data based on the DMAC parameters. After moving one block, it will automatically read the next DMAC parameter set. Hence, the reading speed is enhanced.

The foregoing description of the preferred embodiment of the present invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

1. A direct memory access method for a card reader, said card reader including a direct memory access controller and being coupled to a system, said system including a main memory and a control software, said system executing a driver program to control said card reader, said method comprising:
a. allocating an area of said main memory;
b. establishing a reading table via said control software;
c. setting a parameter set group based on said reading table and moving said parameter set group to said area of said main memory;
d. acquiring an initial address of said parameter set group;
e. reading a parameter value from said initial address;
f. using a direct memory access method to move data based on said parameter value;
g. repeating said steps e and f before reading all said parameter values; and
h. sending out an interrupting signal to said system.

2. The method of claim 1, wherein said reading table is established based on a block status recording area of a memory card.

3. The method of claim 1, wherein said parameter set group is moved by said driver program.

4. The method of claim 1, wherein said parameter set group at least includes a parameter set.

5. The method of claim 1, wherein said initial address of said parameter set group is provided by said driver program to said direct memory access controller.

6. The method of claim 1, wherein each parameter set of said parameter set group includes an origin address of said data and a target address of said data.

7. The method of claim 1, wherein said parameter set group at least includes a plurality of parameter sets and each of said plurality of parameter sets assigns a direct memory access range.

8. The method of claim 7, wherein at least one of said plurality of parameter sets includes a parameter indicating an initial address of a following parameter set.

9. A method for programming a direct memory access controller for a card reader, said card reader including the direct memory access controller and being coupled to a system, said system including a main memory and a control software, said system generating a driver program, said control software establishing a reading table, said driver program setting a parameter set group based on said reading table and moving said parameter set group to an area of said main memory, said system executing said driver program to control said card reader, said method comprising:
a. said driver program providing an initial address of said parameter set group to said direct memory access controller;
b. according to said initial address, said direct memory access controller reading a parameter value, which has not been read, from said parameter set group in a predetermined sequence;
c. said direct memory access controller using a direct memory access method to move data based on said parameter value; and
d. repeating said steps b and c before reading all said parameter values.

10. The method of claim 9, wherein said reading table is established based on a block status recording area of a memory card.

11. The method of claim 9, wherein said parameter set group at least includes a parameter set.

12. The method of claim 9, wherein each parameter set of said parameter set group includes an origin address of said data and a target address of said data.

13. The method of claim 9, wherein said parameter set group at least includes a plurality of parameter sets and each of said plurality of parameter sets assigns a direct memory access range.

14. The method of claim 13, wherein at least one of said plurality of parameter sets includes a parameter indicating an initial address of a following parameter set.
